(19) United States
(12) Patent Application Publication
(10) Pub. No.: US 2020/0173930 A1
(43) Pub. Date: Jun. 4, 2020

(54) JEWELRY AND GEMSTONE IMAGING APPARATUS AND METHODS FOR USING THE SAME

(71) Applicant: Virtual Diamond Boutique Inc., New York, NY (US)

(72) Inventors: Adi Strauss Alonie, ILlit (IL); Victor Levin, ILlit (IL)

(21) Appl. No.: 16/618,012

(22) PCT Filed: Jun. 4, 2018
(86) PCT No.: PCT/US2018/035847

§ 371 Date: Nov. 27, 2019

Related U.S. Application Data
(60) Provisional application No. 62/514,215, filed on Jun. 2, 2017.

(51) Int. Cl. G01N 21/87

(52) U.S. Cl. CPC G01N 21/87

(57) ABSTRACT

An exemplary apparatus for generating an image(s) or a video(s) of a jewelry or a gemstone(s), can be provided, which can include, for example, an enclosure having an opening(s) therein, where a portion(s) of the enclosure can be composed of a light-colored material, a holder coupled to the enclosure for maintaining an imaging arrangement, and a jewelry holding configuration located within the enclosure and configured to maintain the jewelry or gemstone(s) thereon, where the holder can be positioned with respect to the enclosure to provide a field of view of the imaging device through the opening(s) so as to generate the image(s) or the video(s) of the jewelry or gemstone(s).

### CROSS-REFERENCE TO RELATED APPLICATION(S)

This application relates to and claims priority from U.S. Patent Application No. 62/514,215, filed on Jun. 2, 2017, the entire disclosure of which is incorporated herein by reference.

### FIELD OF THE DISCLOSURE

The present disclosure relates generally to an imaging apparatus, and more specifically, to exemplary embodiments of an exemplary jewelry and gemstone imaging apparatus and methods for using the same.

### BACKGROUND INFORMATION

Traditionally, when buying jewelry (e.g., diamond jewelry or other jewelry) and/or gemstones, shoppers would visit one or more local jewelers and review the available selection of jewelry and/or gemstones. Shoppers can inquire about the quality of the diamond, and can inspect the jewelry before purchasing. If the shopper is seeking to purchase a custom-made piece of jewelry, the shopper can physically inspect the diamonds and/or other gemstones ahead of time, and choose a specific diamond and/or other gemstone for the custom jewelry.

As e-commerce has expanded, the number of people purchasing jewelry/gemstones online has also expanded. However, when a shopper purchases jewelry/gemstones online, they are unable to inspect the jewelry prior to purchase. Generally, the shopper will select a particular piece of jewelry, and the website will provide one or more still images of the jewelry/gemstones. Thus, the shopper has to purchase the jewelry/gemstones on faith, as the shopper can only inspect the jewelry after they have purchased it. Additionally, it can be difficult to determine what a piece of jewelry/gemstones will look like from a two-dimensional photo of the jewelry.

Thus, it may be beneficial to provide an exemplary jewelry and gemstone imaging apparatus, and methods for using the same, which can overcome at least some of the deficiencies described herein above.

### SUMMARY OF EXEMPLARY EMBODIMENTS

An exemplary apparatus for generating an image(s) or a video(s) of a jewelry or a gemstone(s), can be provided, which can include, for example, an enclosure having an opening(s) therein, where a portion(s) of the enclosure can be composed of a light-colored material, a holder coupled to the enclosure for maintaining an imaging arrangement, and a jewelry holding configuration located within the enclosure and configured to maintain the jewelry or gemstone(s) thereon, where the holder can be positioned with respect to the enclosure to provide a field of view of the imaging device through the opening(s) so as to generate the image(s) or the video(s) of the jewelry or gemstone(s).

In some exemplary embodiments of the present disclosure, the jewelry holding configuration can be located at a bottom portion of the enclosure and can include a stage and a plate located above the stage. The plate can have a substantially round shape and can a curved edge in a downward direction. The stage and the plate can be approximately or substantially parallel to one another. The stage or the plate can be configured to be tilted or rotated. A computer arrangement can be included which can be configured to automatically tilt or automatically rotate the stage or the plate. The jewelry holding configuration can be configured to be tilted and rotated. The enclosure can include a light source(s). A light can be included, which can be located below the jewelry holding configuration. The imaging arrangement can include a mobile phone or a tablet. The imaging arrangement can have a field of view through the opening(s), and can be configured to generate the image(s) or the video(s).

In certain exemplary embodiments of the present disclosure, the portion(s) of the enclosure can be further composed of a light-diffusing material, which can be composed fully or partially from plastic or fabric material(s). A control panel coupled to the enclosure can be configured to control the apparatus. The apparatus can be configured to control the imaging arrangement using the control panel. The holder can be movable with respect to the enclosure. The holder can include an electrical connection(s), where the enclosure can be configured to provide power to the imaging arrangement using the electrical connection(s) and/or can be in network communication with the imaging arrangement using the electrical connection(s). The electrical connection(s) can be swappable. The enclosure can include a light sensor(s) or a light emitting device(s). The jewelry holding configuration can be located at a top portion of the enclosure, and can include (i) an extension portion extending from the top portion of the enclosure in a downward direction and (ii) a hook portion(s) extending from the extension portion and configured to hold the jewelry(ies) or the gemstone(s).

A further exemplary embodiment can be an exemplary system, method and computer-accessible medium for generating a plurality of images or a video of a piece of jewelry or a gemstone, which can include, for example, activating a light source(s), rotating a jewelry holding configuration containing the piece of jewelry or the gemstone thereon, and generating the images or the video, while the jewelry holding configuration can be rotating, using an imaging arrangement. The jewelry holding configuration can be titled. The Imaging arrangement can include a mobile phone or a tablet. A light level inside an enclosure housing the piece of jewelry can be determined, and a brightness level of the light source can be adjusted based on the light level.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying

Figures showing illustrative embodiments of the present disclosure, in which:

FIG. 1 is an exemplary diagram of an exemplary jewelry and gemstone imaging apparatus according to an exemplary embodiment of the present disclosure;

FIG. 2 is an exemplary diagram of a control panel for the jewelry and gemstone imaging apparatus of FIG. 1 according to an exemplary embodiment of the present disclosure;

FIG. 3 is an exemplary schematic diagram of an exemplary jewelry and gemstone imaging apparatus according to an exemplary embodiment of the present disclosure;

FIG. 4 is an exemplary image of the exemplary jewelry and gemstone imaging apparatus according to an exemplary embodiment of the present disclosure;

FIGS. 5 and 6 are exemplary diagrams of side views of the exemplary jewelry and gemstone imaging apparatus according to an exemplary embodiment of the present disclosure;

FIGS. 7 and 8 are further exemplary diagrams of the exemplary jewelry and gemstone imaging apparatus according to an exemplary embodiment of the present disclosure;

FIG. 9 is an exemplary flow diagram of an exemplary method for generating one or more images or videos of one or more pieces of jewelry according to an exemplary embodiment of the present disclosure; and

FIG. 10 is an illustration of an exemplary block diagram of an exemplary system in accordance with certain exemplary embodiments of the present disclosure.

Throughout the drawings, the same reference numerals and characters, unless otherwise stated, are used to denote like features, elements, components, or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENTS

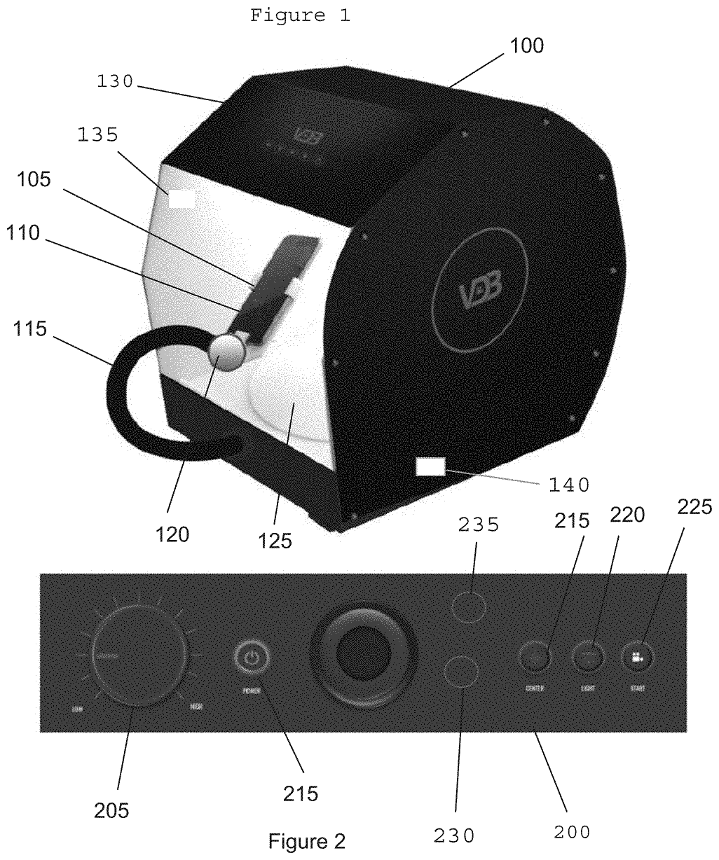

FIG. 1 shows an exemplary diagram of an exemplary jewelry and gemstone imaging apparatus 100 according to an exemplary embodiment of the present disclosure. For example, the exemplary jewelry and gemstone imaging apparatus 100 can be used to generate a plurality of images, or videos, of a piece of jewelry and/or one or more gemstones. The exemplary jewelry and gemstone imaging apparatus 100 is described herein below with reference to imaging jewelry, however, the exemplary jewelry and gemstone imaging apparatus can also be used to image other objects (e.g., the display of objects other than jewelry), for example, diamonds and other gemstones. The images generated using the exemplary jewelry and gemstone imaging apparatus 100 can be stitched together to form a three-dimensional (“3D”) view of the jewelry using an exemplary transcoding procedure performed by a processor/computer, which can be stand alone, provided on a personal digital assistant (e.g., mobile phone, digital pad, etc.). After the 3D view has been generated, a user can view the 3D view of the jewelry and/or gemstone(s) (e.g., on a website). The user can also digitally rotate the jewelry and/or gemstone(s) on screen (e.g., on the website), which can facilitate the user to view all sides and angles of the jewelry and/or gemstone(s).

The exemplary jewelry and gemstone imaging apparatus 100 can include an outer enclosure 130. Outer enclosure 130 can have three or more enclosed sides, and one or more open sides. The open side can facilitate a visual access to a jewelry or gemstone inside of enclosure 130 to facilitate or configure a camera to obtain pictures of the jewelry and/or gemstone(s) inside enclosure 130. Enclosure 130 can have an outer surface that is made from a dark colored material (e.g., black-colored material). This can be used to prevent or at least significantly reduce ambient light outside of enclosure 130 from interfering with the generation of the images. An inner surface of enclosure 130 can be made from a light colored material (e.g., white color). This can facilitate the light inside of enclosure 130 to be diffused throughout enclosure 130, which can facilitate the generation of better quality images.

The material of the inner surface of enclosure 130 can be used to facilitate a diffusion of the light inside of enclosure 130. For example, the diffusive properties of the inner surface of enclosure 130 can prevent the formation of light reflected from the jewelry from interfering with the images being generated. In particular, the jewelry can have certain reflective surfaces or reflective properties. When the light generated by the lighting elements inside of enclosure 130 contacts the jewelry, the light can be reflected back, and can interfere with the quality of the generated images In order to prevent the reflection from interfering with the images, the inner surface of enclosure 130 can be made from particular materials that have suitable diffusive properties to prevent the dispersion of the reflected light. Suitable materials can include, but are not limited to, certain plastics such as acrylic or polycarbonate or fabrics that have diffusive properties.

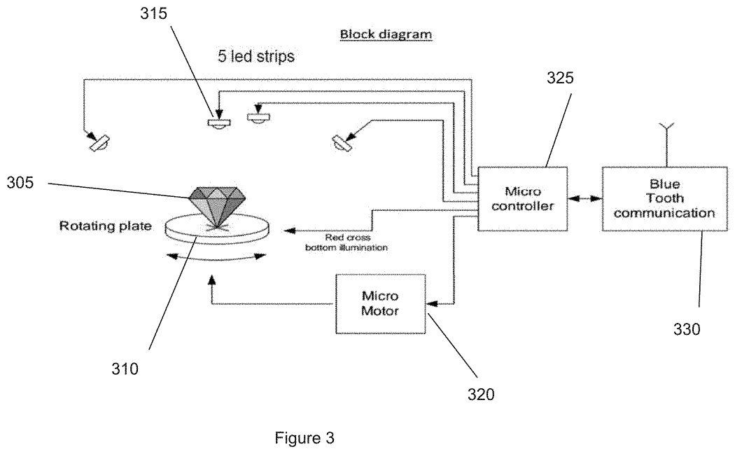

Enclosure 130 can include an arm 115, which can be used to hold the camera. Arm 115 can be fixed (e.g., not moveable), or arm 115 can be flexible to allow the camera to be positioned by the operator of the exemplary jewelry and gemstone imaging apparatus 100. Arm 115 can be connected to enclosure 130 on a first end, and can have a second connection point 120 on an opposite end, which can connect to a camera holder 105. Arm 115 can also facilitate a direct wired connection from enclosure 130 to camera 110 (which can be connected to, included in or part of a mobile device or other personal digital assistant), which can facilitate the exemplary jewelry and gemstone imaging apparatus 100 to control the camera, or vice versa, (e.g., when to take pictures and how many), through a control panel built into or attached to enclosure 130. (See, e.g., control panel shown in FIG. 2). In some exemplary embodiments of the present disclosure, camera 110 can be wirelessly connected to enclosure 130 (e.g., using Bluetooth, Wi-Fi, or any other suitable wireless connection). For example, before beginning the imaging process, camera 110 can be paired directly to enclosure 130 (e.g., using a Bluetooth pairing process), and the camera 110 can be directly controlled using the control panel built into or attached to enclosure 130.

Camera holder 105 can be used to hold camera 110 in place. Camera holder 105 can facilitate camera 110 to be placed in a right-side-up orientation, or an up-side-down orientation, depending on the camera being used. This can facilitate a superior camera lens placement in relation to the jewelry. Additionally, camera holder 105 can rotate along an optical axis of the camera to facilitate a correct positioning of the jewelry in relation to the camera.

Exemplary enclosure 130 can also include a jewelry holding configuration (e.g., platform or a stage 125), which can hold the jewelry and/or gemstone(s) for imaging. The exemplary stage 125 will be described in more detail below. The exemplary camera 110 can include any camera type (e.g., a point and shoot camera, a digital single-lens reflex camera, etc.). Exemplary camera 110 can also include a camera containing arrangement (e.g., a cell phone, tablet, computer etc.). Exemplary camera holder 105 can be removeably attached to arm 115, and can be based on the type of camera or the type of camera containing arrangement (e.g., a larger camera holder for a tablet, or smaller camera holder for a point and shoot camera). Exemplary enclosure 130 can also include a light sensor 135, which will be described in more detail below.

Exemplary enclosure 130 can be electrically connected to camera 110 using camera holder 105. In particular, camera holder 105 can facilitate an electrical connection between enclosure 130 and camera 110 such that enclosure 130 can provide power directly to camera 110. Additionally, camera holder 105 can facilitate an electrical connection between enclosure 130 and camera 110 to provide a network connection between enclosure 130 and camera 110. This can facilitate control of camera 110 using enclosure 130 (e.g., through the control panel shown in FIG. 2). Camera holder 105 can include any connection type to facilitate connection to camera 110. Connections can include, but are not limited to, USB connections (e.g., Micro-USB A, Micro-USB B, USB Mini-b (5-pin), USB Mini-b (4-pin)) Apple 30 pin connector, Apple lightning connector, or fire wire, although not limited thereto). The connection can be fixed to camera holder 105 such that it cannot be changed or swapped. Alternatively, the connection can be removable and/or swappable to facilitate different types of connections depending on the type of camera 110 being used. For example, if an Android mobile phone is being used as camera 110, then the connection can be swapped to be a USB micro connection. If an Apple device (e.g., iPhone) is being used, then the connection can be swapped to be a lightning connection.

Images generated using camera 110 can be stored directly in a storage device of camera 110 for access at a later date and time. In particular, after the images have been stored the storage device in camera 110, camera 110 can be removed from enclosure 130, and can facilitate loading of the images on to a website for view by a user. The images can be processed and uploaded directly using camera 110. Alternatively, the images can be removed from the storage device of camera 110 (e.g., on to a computer, tablet, or other computing device) to be loaded by that device. As an alternative, or in addition to storing the images on the storage device of camera 110, enclosure 130 can include a storage port 130 which can facilitate storing of the images to another data storage device. For example, storage port 140 can include a USB port, which can facilitate loading of the images directly on to a USB storage device (e.g., an external hard drive or a thumb/flash drive). Alternatively, or in addition, storage port 140 can include a secure digital (“SD”) slot/port, such as a microSD slot/port, which can facilitate the insertion of an SD card for saving or storing the generated images. The images saved on the SD card can then be loaded on to a computing device for processing and uploading at a later time.

FIG. 2 shows an exemplary diagram of a control panel 200 for the jewelry and gemstone imaging apparatus 100 of FIG. 1, according to an exemplary embodiment of the present disclosure.

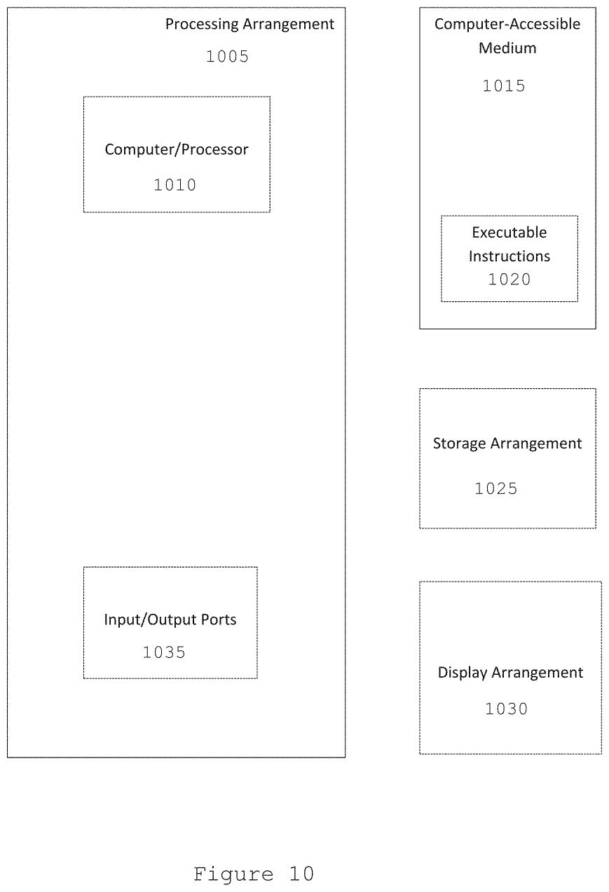

Exemplary control panel/bar 200 show in FIG. 2 can be used to control the operation of the exemplary jewelry and gemstone imaging apparatus 100. For example, exemplary control panel 200 can include a power button 215, which can be used to turn the exemplary jewelry and gemstone imaging apparatus 100 on and off. A dial 205 can be used to adjust a light level (e.g., brightness) inside of enclosure 130. The brightness level can be based on the lumen output from the plurality of LEDs. For example, the brightness level can range from 0 lumens to 1,500 lumens. In some exemplary embodiments of the present disclosure, the brightness level can range from 1,000 lumens to 1,500 lumens. Control panel/bar 200 can also include an auto brightness button 230. The auto brightness button 230 can facilitate an automatic level adjustment of the brightness level inside of enclosure 130. In particular, after the auto brightness button 230 is pressed, light sensor 135 can be used to sample the amount of light present inside of enclosure 130, which can be based on the ambient light and the jewelry placed inside of enclosure 130. The light level can be analyzed (e.g., using the exemplary system described below in FIG. 10) to automatically determine a brightness level for the lighting that is suitable for generating the images. The brightness level can also be adjusted automatically based on the specifications of camera 110 (e.g., based on the camera sensor in camera 110). For example, a lesser quality camera may need a brighter light level, and conversely, a better quality camera may only need a lower light level.

Control panel/bar 200 can also include (i) a centering button 215, which can be used to center stage 125 inside of the exemplary jewelry and gemstone imaging apparatus 100, (ii) a light button 220, which can turn a light below stage 125 on and off, and (iii) a start button 225, which can start the image generation process. Additionally, control panel/bar 200 can include a tilt button 235, which can be used to set the tilt angle for one or both of stage 125 and dome 515. Further, while control panel/bar 200 is shown as having physical buttons, as an alternative, or in addition, control panel/bar 200 can be a touchscreen (e.g., a liquid crystal display touchscreen), which can include virtual buttons that correspond to the physical buttons discussed above. Further, the touchscreen can be user configurable such that the layout of the buttons on the touchscreen can be modified by the user.

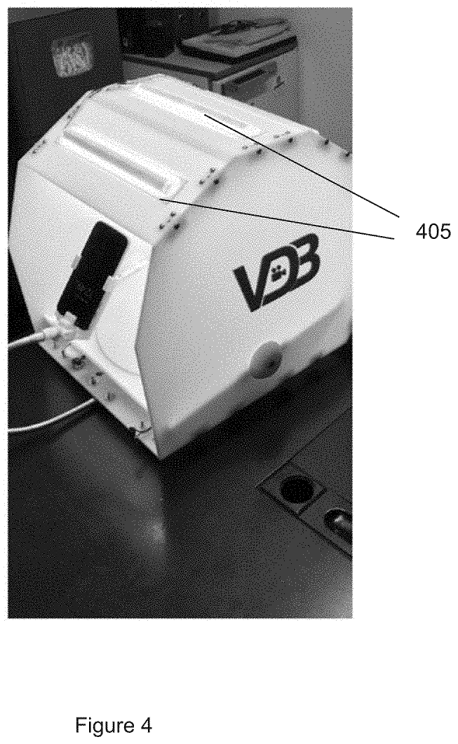

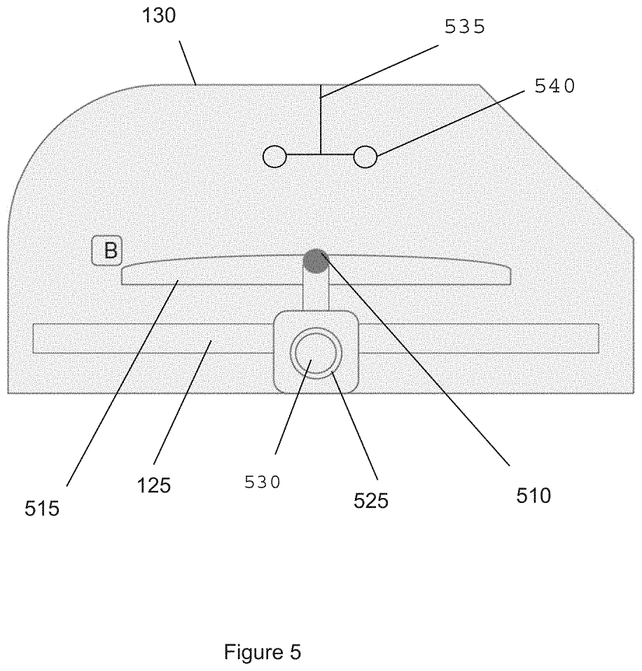

FIG. 3 shows an exemplary schematic diagram of the exemplary jewelry and gemstone imaging apparatus 100 according to an exemplary embodiment of the present disclosure. For example, a piece of jewelry or a gemstone 305 can be placed (e.g., can sit on) a stage or plate 310 (e.g., which can be rotated and/or tilted as described below). Plate 310 can be controlled using, for example, a motor (e.g., a micro motor) 320. Motor 320 can be controlled used a microcontroller 325. Microcontroller can 325 can be embedded and/or housed in enclosure 130, and can be controlled using control panel 200. Alternatively, microcontroller 325 can be controlled using a computer processor connected to camera 110 (e.g., through a wired connection from camera 110 to enclosure 130 or using a wireless connection from such computer processor of camera 110 to enclosure 130, for example, using Bluetooth communication module 330). Microcontroller 325 can also be used to control light source 315, which can include one or more light sources such as light emitting diodes (“LED”s). For example, light source 315 can include multiple light strips (e.g., multiple LED strips), which can be used to light jewelry 305 from different angles. (See e.g., LED strips 405 shown in FIG. 4). In some exemplary embodiments of the present disclosure, the number of LED strips can be five, although other numbers can be used (e.g., 2, 3, 4, 6, 7, and 8 strips). Light source 315 can be cool white LEDs, which can facilitate better image quality. Light source 315 can have a wide angle illumination in a range of approximately 140-160 degrees, which can provide beneficial and even flooding of light to facilitate superior image conditions, and also reduce optical artifacts such as shadows and shining spots. Light source 315 can have high uniformity properties, which can reduce the optical artifacts such as shinings and reflection/white spots on the video frames or the images.

In an exemplary embodiment of the present disclosure, an external or portable device can be used to control the exemplary jewelry and gemstone imaging apparatus 100. For example, a mobile phone, tablet or the like can include an application thereon that can be paired with one or both of the exemplary jewelry and gemstone imaging apparatus 100 or camera 110. The exemplary mobile phone can control all functions on the exemplary jewelry and gemstone imaging apparatus 100 including (e.g., the light source, rotation, tilt angle, etc.), as well as the camera function on camera 110 (e.g., when to take the images and video and the number of images to take).

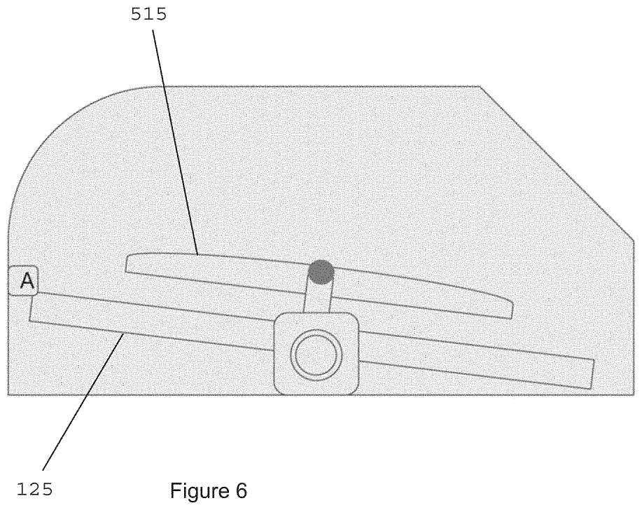

FIGS. 5 and 6 show exemplary diagrams of side views of the exemplary jewelry and gemstone imaging apparatus according to an exemplary embodiment of the present disclosure. For example, as shown in FIG. 5, enclosure 130 can include stage 125 at a bottom portion of enclosure 130. Stage 125 can include a raised bed, or domed portion, (e.g., dome 515), which the jewelry can be provided on. Alternatively, stage 125 is not needed, and the exemplary jewelry and gemstone imaging apparatus can only include a domed portion. Dome 515 can be raised above stage 125 to facilitate better imaging of the jewelry. Dome 515 and stage 125 can tilt (e.g., towards the camera or away from the camera) to facilitate images to be taken at different angles. (See e.g., FIG. 6). Dome 515 and stage 125 can tilt together such that dome 515 and stage 125 are always parallel to one another, or approximately parallel. However, dome 515 can also tilt separately from (e.g., independently of) stage 125. This can facilitate steeper angles for imaging of the jewelry. The exemplary tilt angle of the combined dome 515 and stage 125 can be 0 degrees (e.g., flat) to approximately 15 degrees (e.g., 12 degrees to 18 degrees). Additionally, stage 125 can be tilted from 0 degrees to approximately 15 degrees (e.g., 12 degrees to 18 degrees), and dome 515 can be separately tilted from 0 degrees to approximately 15 degrees (e.g., 12 degrees to 18 degrees). Thus, the combined tilting can be from 0 degrees to approximately 36 degrees, although other angles can be utilized. Dome 515 and stage 125 can also be rotated, which can facilitate multiple images of the jewelry to be taken (e.g., on multiple sides), which can then be stitched together. Dome 515 and stage 125 can rotate a full 360 degrees, and dome 515 and stage 125 can be rotated together (e.g., when one rotates the other rotates) or dome 515 and stage 125 can be independently rotated.

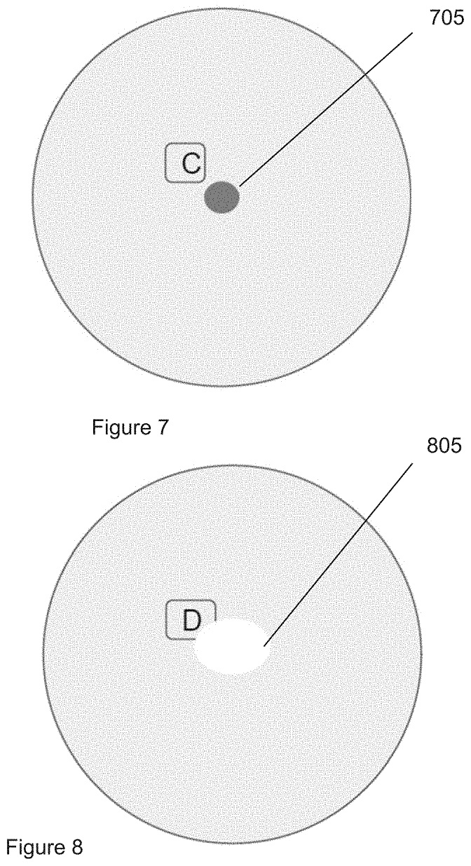

In order to facilitate the tilting and rotating of dome 515 and stage 125, enclosure 130 can include moveable portion 525. Moveable portion 525 can include a pivot point 530, about which stage 125, and dome 515, can pivot (e.g., tilt). Moveable portion 525 can also facilitate a rotation of a combined stage 125 and dome 515 (e.g., such that they rotate together) or only of dome 515 (e.g., such that stage 125 does not rotate). Dome 515 can be curved at its edges, which can facilitate a wider field of view for the images of the jewelry. This can facilitate a maximum depth of field for the generated images. Additionally, dome 515 can include a center portion 510 (see e.g., FIG. 7), which can be a placement point for the jewelry, and can also be a pivot point about which only dome 515 can pivot.

The exemplary jewelry and gemstone imaging apparatus 100 can include a hanging portion (e.g., upper stage) 535 attached to the top of Dome 515. Hanging portion 535 can include one or more hook/holder portions 540, which can be used to hold jewelry that can be hung (e.g., bracelets, necklaces, etc.). Hanging portion 535 can be rotated (e.g., automatically rotated) to facilitate the generation of multiple images or a video of the hanging jewelry.

As shown in FIG. 8, stage 125 can include a light source 805, which can generate light from under stage 125 to light jewelry on dome 515. Light source 805 can include an LED light source, and can generate a brightness level of between 0 and 500 lumens. In some exemplary embodiments of the present disclosure, the brightness level can be between 100 lumens and 150 lumens. The brightness level can be selected such that it does not interfere with the CMOS chip of the camera. Additionally, the brightness level of light source 805 can be based on the brightness level of light source 315 (e.g., the ratio of the brightness level of light source 315 to light source 805 can be 10 to 1, or other suitable ratios, including, but no limited to, 8 to 1, 9 to 1, 11 to 1, and 12 to 1). Light source 805 can be in the cool color range, and can facilitate multi-directional lighting of the jewelry to facilitate superior image quality.

The exemplary jewelry and gemstone imaging apparatus can incorporate any camera, as described above. However, the use of a cell phone or tablet can facilitate easier operation of the exemplary jewelry and gemstone imaging apparatus. For example, an application can be installed on the camera or tablet which can facilitate control of the enclosure. In particular, the application can control the lighting of the enclosure, the rotation of stage 125 and dome 515, and the tilt angle of stage 125 and dome 515. The application can sample the lighting conditions (e.g., using the camera), and can adjust the brightness level of light sources 315 and 805 depending on the lighting conditions. The application can also turn off certain lights in light source 315 to facilitate better image quality by adjusting the amount of overall light in the enclosure. The application can then activate the imaging process, which can include rotating dome 515 and taking multiple images, or a video, using the camera on the cell phone or tablet. The number of images taken or generated can be based on the quality of the 3D image to be generated. The application can also activate and deactivate light sources 315 and 805 during the image taking process in order to facilitate superior image generation.

As an alternative to controlling the image generating process using a mobile phone or tablet, microcontroller 325 can be used to perform the image generating process. For example, microcontroller 325 can automatically control the amount of light, which light sources are activated, the tilt angle of dome 515, and the rotation of dome 515. Microcontroller 325 can then cause the camera to generate the images, or video, using the wired or wireless connection to the camera. Thus, by pressing a single button (e.g., start button 225 on control panel 200), the entire 3D image, or video generating process, can be performed automatically. Alternatively, or in addition, the user can manually adjust the brightness level, the number of light sources activated, and the tilt angle.

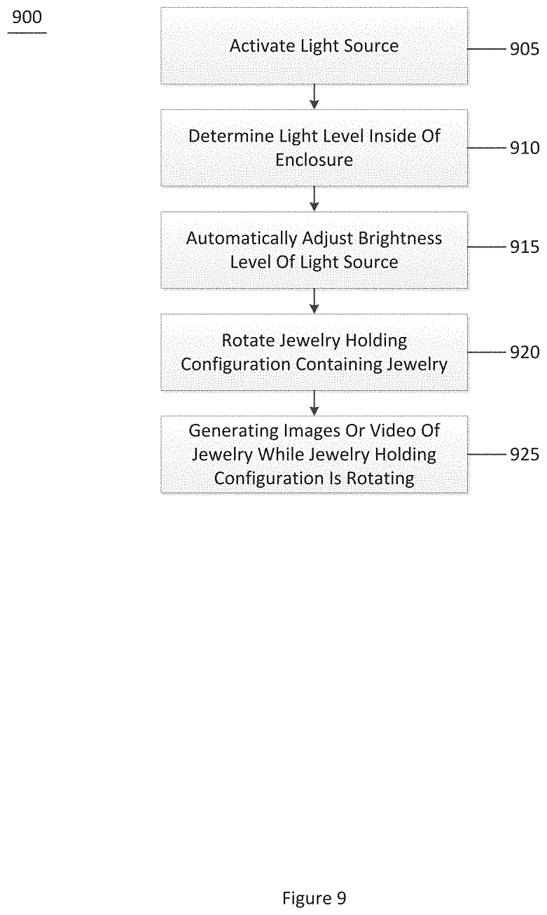

FIG. 9 shows an exemplary flow diagram of an exemplary method 900 for generating one or more images or videos of one or more pieces of jewelry according to an exemplary embodiment of the present disclosure. For example, at procedure 905, a light source can be activated. At procedure 910, a light level inside of an enclosure housing the jewelry can be determined, and a brightness level of the light source can be automatically adjusted at procedure 915 based on the light level. At procedure 920, the jewelry holding configuration containing the jewelry thereon can be rotated, and the images or video of the jewelry can be generated at procedure 925 while the jewelry holding configuration is rotating.

FIG. 10 shows a block diagram of an exemplary embodiment of a system according to the present disclosure. For example, exemplary procedures in accordance with the present disclosure described herein can be performed by a processing arrangement and/or a computing arrangement 1005. Such processing/computing arrangement 1005 can be, for example entirely or a part of, or include, but not limited to, a computer/processor 1010 that can include, for example one or more microprocessors, and use instructions stored on a computer-accessible medium (e.g., RAM, ROM, hard drive, or other storage device).

As shown in FIG. 10, for example a computer-accessible medium 1015 (e.g., as described herein above, a storage device such as a hard disk, floppy disk, memory stick, CD-ROM, RAM, ROM, etc., or a collection thereof) can be provided (e.g., in communication with the processing arrangement 1005). The computer-accessible medium 1015 can contain executable instructions 1020 thereon. In addition or alternatively, a storage arrangement 1025 can be provided separately from the computer-accessible medium 1015, which can provide the instructions to the processing arrangement 1005 so as to configure the processing arrangement to execute certain exemplary procedures, processes, and methods, as described herein above, for example.

Further, the exemplary processing arrangement 1005 can be provided with or include an input/output arrangement 1035, which can include, for example a wired network, a wireless network, the internet, an intranet, a data collection probe, a sensor, etc. As shown in FIG. 10, the exemplary processing arrangement 1005 can be in communication with an exemplary display arrangement 1030, which, according to certain exemplary embodiments of the present disclosure, can be a touch-screen configured for inputting information to the processing arrangement in addition to outputting information from the processing arrangement, for example. Further, the exemplary display 1030 and/or a storage arrangement 1025 can be used to display and/or store data in a user-accessible format and/or user-readable format.

The terms “coupled”, “coupled to”, and “coupled with” as used herein each mean a relationship (e.g., wired or wireless) between or among two or more devices, apparatus, files, programs, media, components, networks, systems, subsystems, and/or means, constituting any one or more of (i) a connection, whether direct or through one or more other devices, apparatus, files, programs, media, components, networks, systems, subsystems, or means, (ii) a communications relationship, whether direct or through one or more other devices, apparatus, files, programs, media, components, networks, systems, subsystems, or means, and/or (iii) a functional relationship in which the operation of any one or more devices, apparatus, files, programs, media, components, networks, systems, subsystems, or means depends, in whole or in part, on the operation of any one or more others thereof.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1. An apparatus for generating at least one of at least one image or at least one video of at least one of jewelry or a gemstone, comprising:
an enclosure having at least one opening therein, wherein at least one portion of the enclosure is composed of a light-colored material;
a holder coupled to the enclosure for maintaining an imaging arrangement; and
a jewelry holding configuration located within the enclosure and configured to maintain the at least one of the jewelry or the gemstone thereon, wherein the holder is positioned with respect to the enclosure to provide a field of view of the imaging device through the at least one opening so as to generate the at least one of the at least one image or the at least one video of the at least one of the jewelry or the gemstone.

2. The apparatus of claim 1, wherein the jewelry holding configuration is located at a bottom portion of the enclosure and includes a stage and a plate located above the stage.

3. The apparatus of claim 2, wherein the plate has a substantially round shape and has a curved edge in a downward direction.

4. The apparatus of claim 2, wherein the stage and the plate are approximately or substantially parallel to one another.

5. The apparatus of claim 2, wherein at least one of the stage or the plate is configured to be at least one of tilted or rotated.

6. The apparatus of claim 5, further comprising a computer which is configured to at least one of automatically tilt or automatically rotate the at least one of the stage or the plate.

7. The apparatus of claim 1, wherein the jewelry holding configuration is configured to be tilted and rotated.

8. (canceled)

9. The apparatus of claim 1, further comprising at least one light source located below the jewelry holding configuration.

10. The apparatus of claim 1, wherein the imaging arrangement includes at least one of a mobile phone or a tablet.

11. The apparatus of claim 1, wherein the imaging arrangement has a field of view through the at least one opening, and is configured to generate the at least one of the at least one image or the at least one video.

12. The apparatus of claim 1, wherein the at least one portion of the enclosure is further composed of a light-diffusing material.

13. The apparatus of claim 12, wherein the light-diffusing material is at least one of plastic or fabric.

14-16. (canceled)

17. The apparatus of claim 1, wherein the holder is movable with respect to the enclosure.

18. The apparatus of claim 1, wherein the holder includes at least one electrical connection, and wherein the enclosure is at least one of (i) configured to provide power or energy to the imaging arrangement using the at least one electrical connection, or (ii) is in network communication with the imaging arrangement using the at least one electrical connection.

19. The apparatus of claim 18, wherein the at least one electrical connection is swappable.

20. (canceled)

21. The apparatus of claim 1, wherein the jewelry holding configuration is located at a top portion of the enclosure.

22. (canceled)

22. A method for generating at least one of a plurality of images or a video of at least one piece of jewelry, comprising:
activating at least one light source;
rotating a jewelry holding configuration containing the at least one piece of jewelry thereon; and
generating the at least one of the images or the video, while the jewelry holding configuration is rotating, using an imaging arrangement.

23. The method of claim 22, further comprising tilting the jewelry holding configuration.

24-25. (canceled)

26. A non-transitory computer-accessible medium having stored thereon computer-executable instructions for generating at least one of a plurality of images or a video of at least one piece of jewelry, wherein, when a computer arrangement executes the instructions, the computer arrangement is configured to perform procedures comprising:
activating at least one light source;
causing a rotation of a jewelry holding configuration containing the at least one piece of jewelry thereon; and
generating the at least one of the images or the video, while the jewelry holding configuration is rotating, using an imaging arrangement.

27-31. (canceled)

32. The apparatus of claim 21, wherein the jewelry holding configuration includes (i) an extension portion extending from the top portion of the enclosure in a downward direction and (ii) at least one hook portion extending from the extension portion and configured to hold the at least one of the jewelry or the gemstone.
